(19) United States
(12) Patent Application Publication
(10) Pub. No.: US 2003/0001885 A1
(43) Pub. Date: Jan. 2, 2003

(54) Method of generating a dynamic editable table in a web page

(76) Inventors: Kuang-Shin Lin, Taipei (TW); Jeff Song, Taipei (TW); Yi-Song Li, Tianjin (CN)

Correspondence Address: BIRCH STEWART KOLASCH & BIRCH, PO BOX 747, FALLS CHURCH, VA, 22040-0747, US

(21) Appl. No.: 10/174,965

(22) Filed: Jun. 20, 2002

(30) Foreign Application Priority Data
Jun. 29, 2001 (TW) 90115892

(51) Int. Cl. G09G 5/00; G06F 17/30; G06F 15/16

(52) U.S. Cl. 345/738; 707/10; 709/203

(57) ABSTRACT

The specification discloses a method of generating a dynamic editable table in a web page. The method includes the steps of: transmitting data from a server to a client according to a user's instructions; using the data to generate the dynamic editable table and display it on a web page shown on the client's browser; allowing the client to perform various editing and statistical operations on the dynamic editable table; and simultaneously modifying and storing the corresponding data on the server.

### BACKGROUND OF THE INVENTION

1. Field of the Invention

The invention relates to a method of generating a dynamic editable table and, in particular, to a method of generating a dynamic editable table in a web page.

2. Related Art

Tables generated by the current web page design technology are static. Users can only follow designated ways to browse the table, but are unable to perform complicated operations such as appending, modifying, viewing real-time counting and sorting. Even if they allow a user to perform simple operations on the table data, new data have to be transmitted from the server in order to update the web page, breaking continuous operations on the table.

Furthermore, more and more web page designs provide real-time update functions for controls, input and editing from multiple parties. It is thus highly desirable to have a method that can generate a dynamic editable table in a web page.

### SUMMARY OF THE INVENTION

The invention discloses a method for implementing a dynamic table in a web page. Such a dynamic table allows such functions as appending, deleting, and modifying records in the table. It can also implement such functions as inputting counting, sorting, recording selections, and input device controls. All dynamic operations are completed on the client end without updating the web page from the server.

An objective of the invention is the method of generating a dynamic editable table in a web page. It uses Java Script to implement the dynamic interactive operations of the table.

The disclosed method can dynamically insert buttons, selection frames, input frames and other controls and HTML elements in the table. Thus, the user can use the browser to browse data and, at the same time, edit and organize data.

Another objective of the invention is to allow a programmer to repeatedly use the same table at various times and in various ways without designing it all over again.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a block diagram of the main functional module of the invention;

FIG. 2 is a flowchart of the data generating module;

FIG. 3 is a flowchart of the table processing module;

FIG. 4 is an operational flowchart of the mouse operation in the dynamic operation module;

FIG. 5 is an operational flowchart of the keyboard operation in the dynamic operation module;

FIG. 6 is an operational flowchart of the table assigned event;

FIG. 7 is a flowchart of storing data; and

FIG. 8 is a schematic view showing the effects of generating a dynamic editable table in a web page.

### DETAILED DESCRIPTION OF THE INVENTION

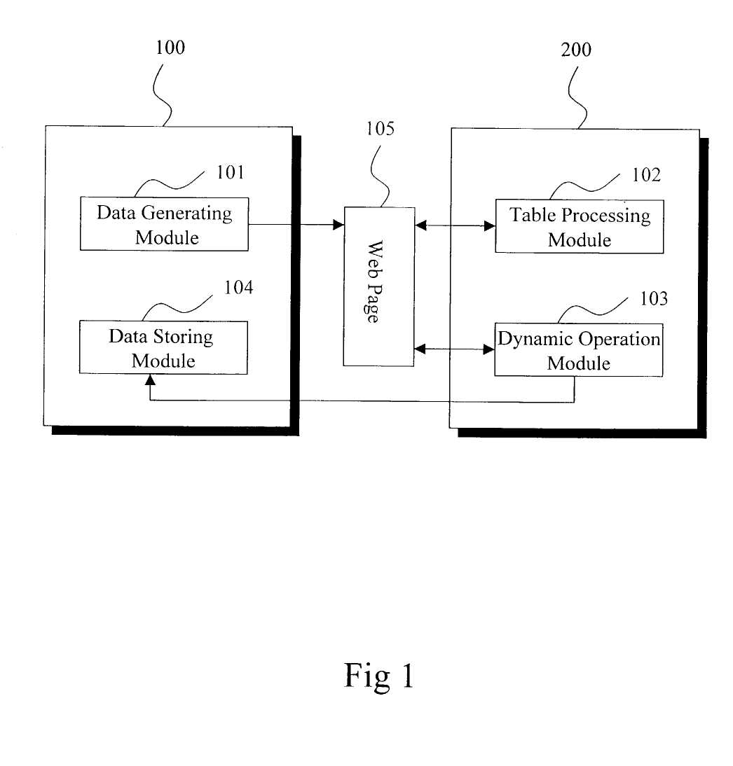

As shown in FIG. 1, the main functional module of the invention includes a data generating module 101, a table processing module 102, a dynamic operation module 103, and a data storing module 104. The data generating module 101 transmits data from a server 100 to a client 200. The table processing module 102 generates a dynamic table and displays it on a web page 105 shown on the browser at the client's computer. The dynamic operation module 103 allows a user to perform various operations such as editing and counting on the dynamic table. The operation result is directly modified on the web page 105. The data storing module 104 makes simultaneous modifications of the data on the server 100. The function of each module is described as follows.

(1) The Data Generating Module 101:

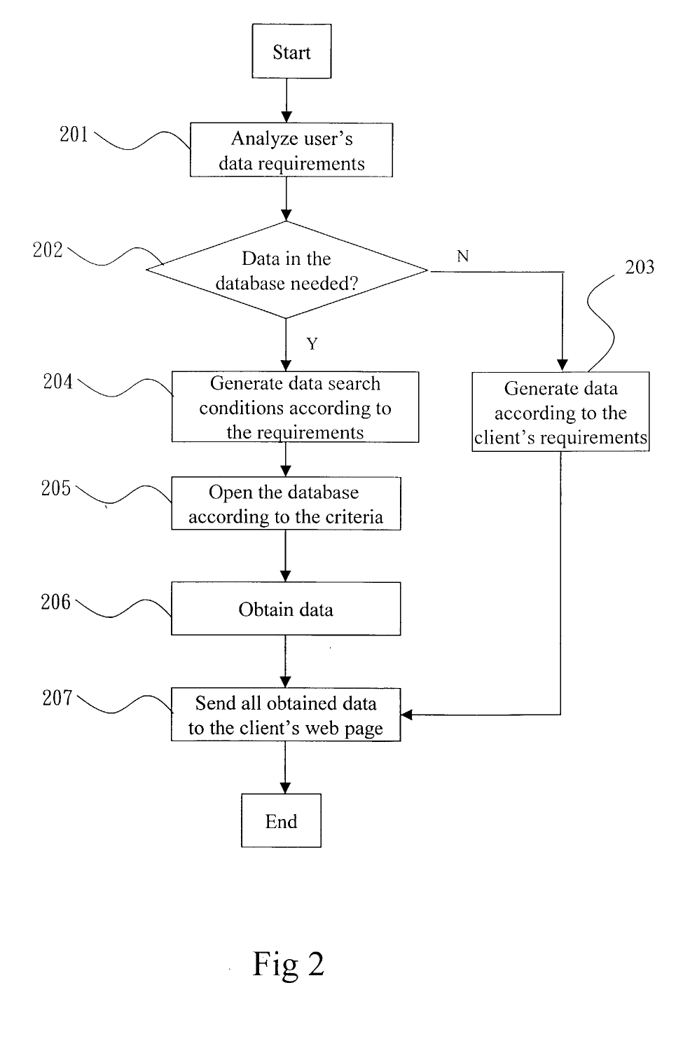

As shown in FIG. 2, step 201 analyzes a user's data request. Step 202 determines whether data in a database are needed. If the data is not needed, data are directly generated according to the user's request in step 203 or a blank data is provide for the user to fill out. If the database is used, data search criteria satisfying the request are generated in step 204. Step 205 opens the database according to the criteria. Data are obtained in step 206. Finally, the “Response.Write” method is employed to distribute all obtained data to the web page 105 shown to the client 200 in step 207.

(2) The Table Processing Module 102:

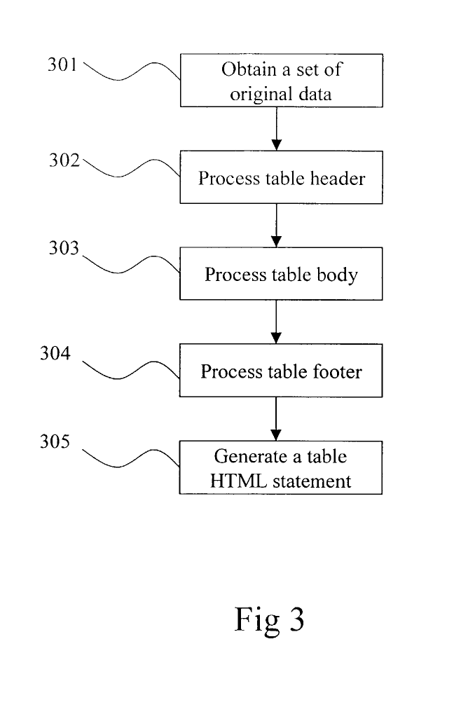

In the web page 105 shown to the client 200, the table processing module 102 directly processes the original data to generate a table. This procedure is shown in FIG. 3. Step 301 obtains a set of original data. Step 302 processes the table header, generating a field header HTML statement, providing sorting events at field headers and assigning field widths. Step 303 process the table body, generating HTML statements for each record, providing selected record events, editing methods, controls, and HTML elements in the table body. Step 304 processes the table footer, setting a statistical value. Finally, step 305 generates the table HTML statements. The table header, the table body and the table footer are combined together and shown in the web page 105.

(3) Dynamic Operation Module 103:

The user operations include mouse operation 1031 and keyboard operation 1032.

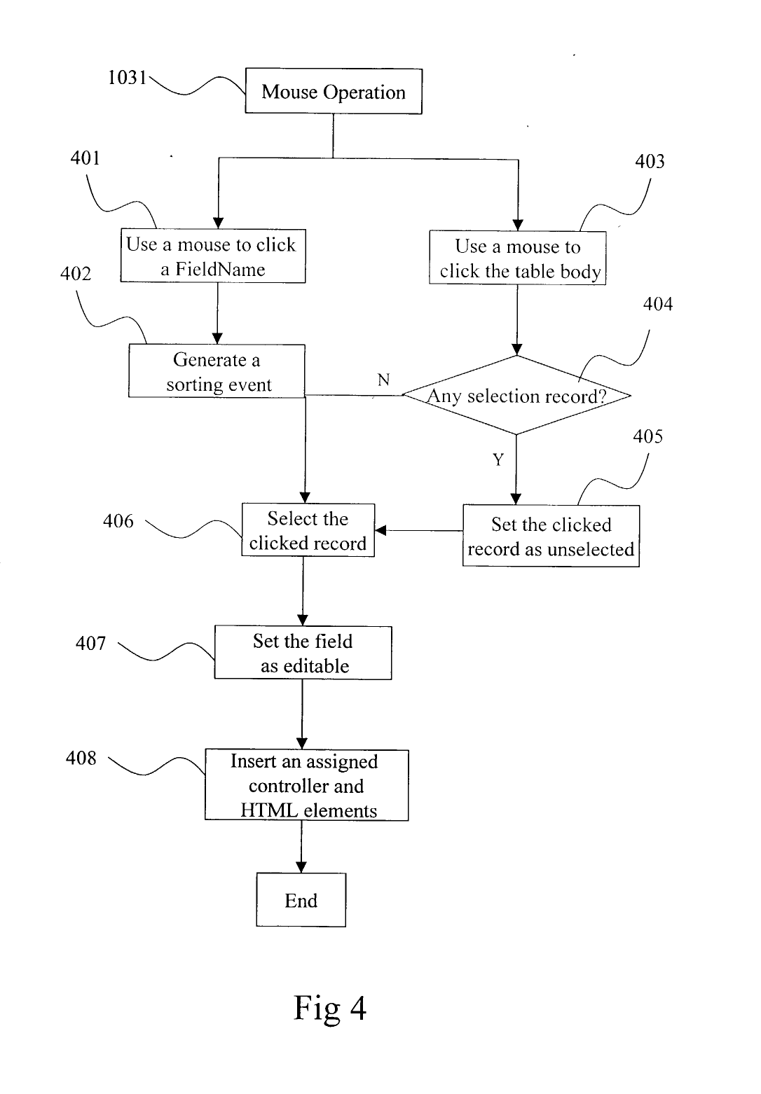

As shown in FIG. 4, when the user clicks a FieldName (step 401), the module generates a sorting event (step 402). The clicked field is then sorted in ascending order. Clicking once more sorts the field in descending order. If the user clicks the table body (step 403), the module determines whether there is any selection record (step 404). If there is a selection record, then the selection record is set as unselected (step 405). For example, if some row is selected, then the contents in the row are stored and the inserted control for the row disappears. The row is then set as unselected. If there is no selection record, then the clicked record is marked as selected (step 406), e.g., the contents of a clicked row are set as selected. Afterwards, a field is set as editable (step 407) to generate an input frame for the user to select records for editing. Assigned controls and HTML elements are then inserted (step 408) for the user to manipulate.

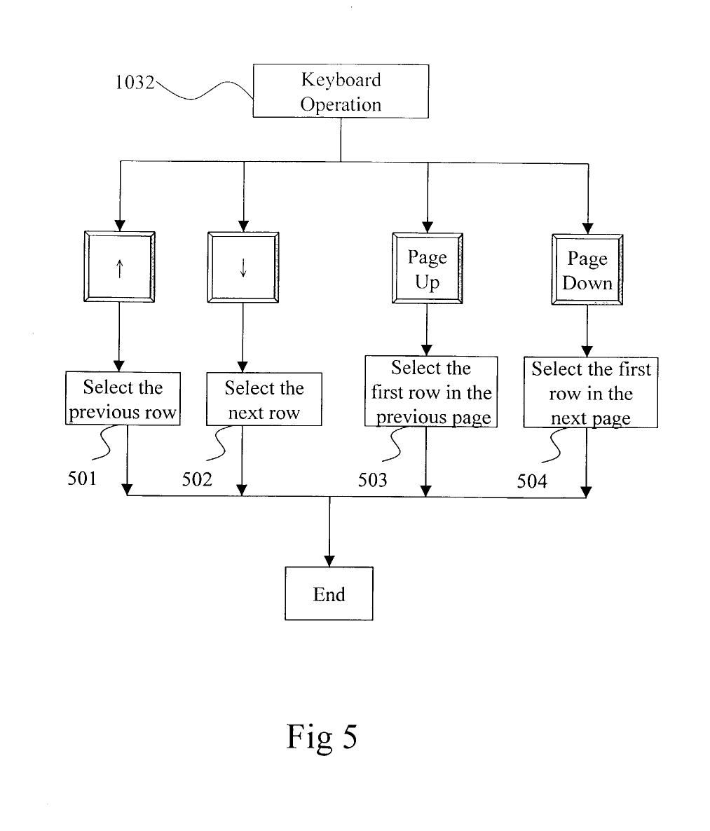

The keyboard operation is shown in FIG. 5. When the user presses direction keys on the keyboard, the original contents in the row are stored and the original inserted control for the row disappears. Pressing the Up key selects its previous row (step 501) and the Down key selects the following row (step 502). Pressing the PageUp key selects the first row of the previous page (step 503) while the PageDown key selects the first row of the following page (step 504).

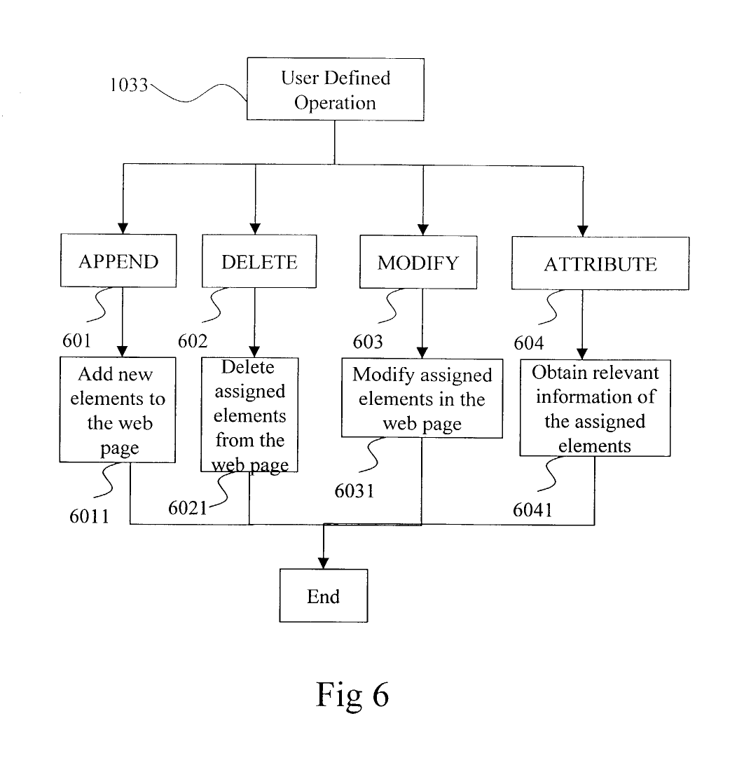

The user defined operation 1033 is shown in FIG. 6. Through the default table generating method, the user can choose APPEND (step 601) to add new elements to the web page 105 (step 6011), DELETE (step 602) to delete assigned elements from the web page 105 (step 6021), MODIFY (step 603) to modify assigned elements in the web page 105 (step 6031), and ATTRIBUTE (step 604) to obtain the attributes of the currently assigned elements, such as the row number and content (step 6041).

(4) The Data Storing Module 104:

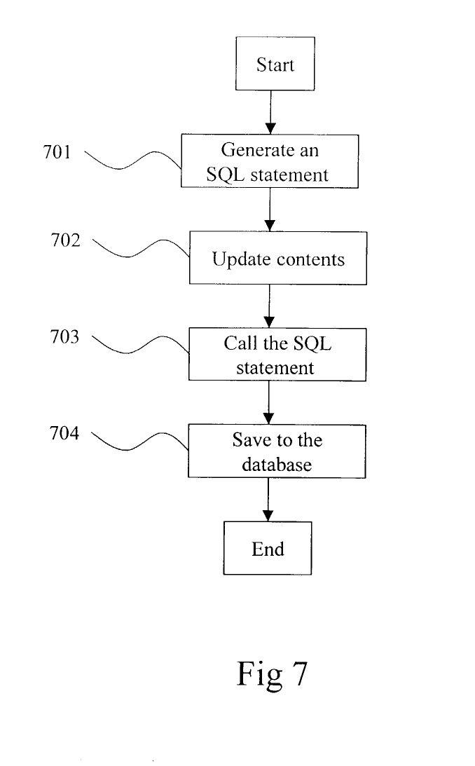

This module operates at the server end, as shown in FIG. 7. First, an SQL statement is generated (step 701). Such commands as UPDATE, DELETE, and INSERT are used to assign contents to be updated (step 702). Afterwards, the open method of data connection is used to call the SQL statement (step 703) and to store data in the database (step 704).

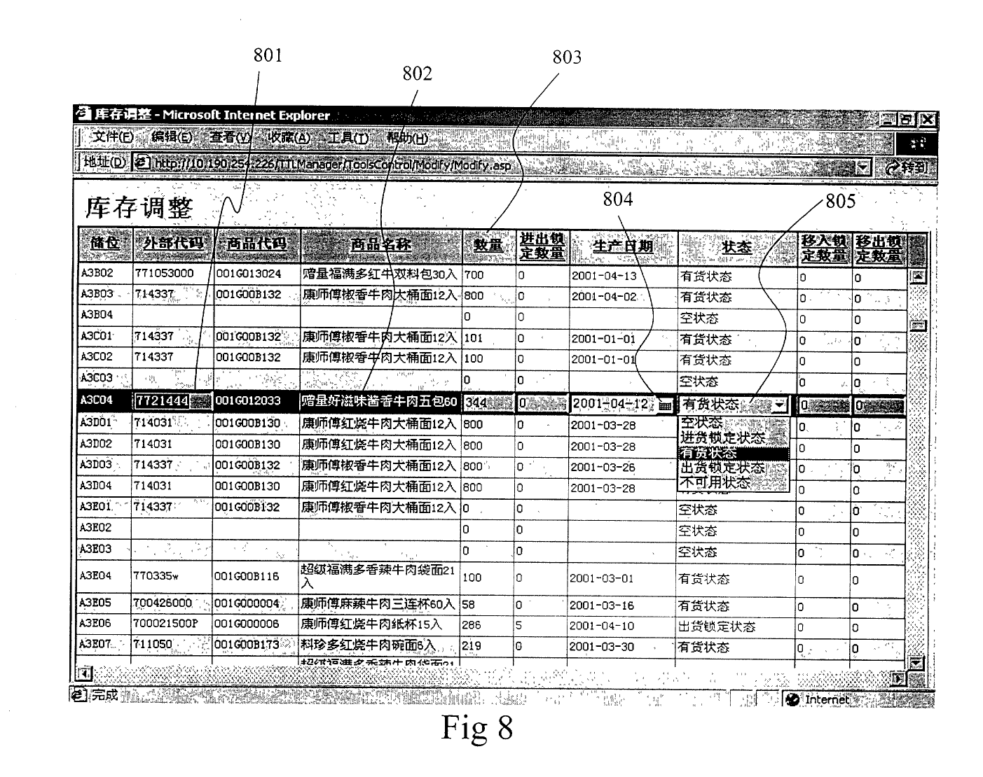

As shown in FIG. 8, all tables are generated on a web page using the disclosed method. They satisfy all of the user's requirements in operating data. In the selected data 802, the user can directly enter data to editable fields 801 such as “External Code” and “Quantity”. The user can also press the Date selection button 804 to enter a date. By pressing fields 803 such as “Quantity”, “Product Code”, and “Locator”, data will be sorted accordingly. Furthermore, the user can choose a selection menu 805 to select the locator status.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of generating a dynamical editable table in a web page, which comprises the steps of:
transmitting data from a server to a client according to a user's request;
generating the dynamical editable table using the data and displaying it in a web page shown on the client's browser;
allowing the client to perform various editing and statistical operations on the dynamical editable table; and
making simultaneous modifications on the corresponding data and storing them on the server.

2. The method of claim 1, wherein the dynamical interactive operation function of the table is implemented using Java Script.

3. The method of claim 1, wherein the data are generated by a data generating module.

4. The method of claim 3, wherein the data generating module executes the steps of:
analyzing a user's data request;
allowing the user to use data in a database;
generating data search criteria satisfying the request;
opening the database according to the criteria and obtaining the data; and
sending the obtained data to the web page shown on the client's computer.

5. The method of claim 4 further comprising the step of the client's direct request for generating data.

6. The method of claim 1, wherein the step of generating the dynamical editable table is achieved through a table processing module.

7. The method of claim 6, wherein the table processing module executes the steps of:
obtaining a set of original data;
processing a table header by generating a field header HTML statement, providing sorting events at field headers and assigning field widths;
processing a table body by generating each record HTML statement, providing selected record events, editing methods, control, and HTML tags in the table body;
processing the table footer by setting a statistical value;
generating a table HTML statement; and
combining the table header, the table body and the table footer together and displaying them in the web page.

8. The method of claim 1, wherein the step of performing various editing and statistical operations on the dynamical editable table is achieved using a dynamical operation module.

9. The method of claim 8, wherein the dynamical operation module is selected from the group comprising the combinations of mouse operation, keyboard operation and user defined operation.

10. The method of claim 9, wherein the dynamical operation module generates a sorting event when the user chooses the mouse operation and clicks a FieldName.

11. The method of claim 9, wherein a record is selected when the user chooses the mouse operation and clicks a table body.

12. The method of claim 11, where when the clicked record sets the field as editable and generates an editable input frame for the user to select records to edit.

13. The method of claim 12 further comprising the step of inserting assigned controls and HTML elements for the user to use.

14. The method of claim 9, wherein when the user can select from the group comprising the combinations of appending records, deleting record, modifying records and obtaining the current record parameters when he chooses the user defined operation.

15. The method of claim 1, wherein the step of storing the data is achieved using a data storing module.

16. The method of claim 15, wherein the data storing module further comprises the steps of:
generating an SQL statement;
assigning updated contents;
calling the SQL statement; and
storing the SQL statement in a database.

17. The method of claim 16, wherein the step of assigning updated contents uses clauses such as UPDATE, DELETE and INSERT to update the contents.
